(19) United States
(12) Patent Application Publication
(10) Pub. No.: US 2024/0217555 A1
(43) Pub. Date: Jul. 4, 2024

(54) Autonomous Caravanning Using Ultra-Wideband Communication

(71) Applicant: GOOGLE LLC, Mountain View, CA (US)

(72) Inventor: Dongeek Shin, Mountain View, CA (US)

(21) Appl. No.: 17/921,028

(22) PCT Filed: Mar. 15, 2022
(86) PCT No.: PCT/US22/20324

§ 371 Date: Oct. 24, 2022

(51) Int. Cl. B60W 60/00; B60W 30/165

(52) U.S. Cl. CPC B60W 60/0025; B60W 30/165; B60W 2556/65; B60W 2720/106

(57) ABSTRACT

To automatically follow a host vehicle to a destination location, a client device in a vehicle identifies a host vehicle to follow to a destination location, transmits a communication signal to the identified host vehicle, and receives a response signal from the identified host vehicle. The client device determines a position of the host vehicle relative to the vehicle based on a round trip time of the communication signal and the response signal, and adjusts control of the vehicle in accordance with the position of the host vehicle relative to the vehicle.

### FIELD OF THE DISCLOSURE

This disclosure relates to autonomous caravanning using ultra-wideband (UWB) communications between client devices in a host vehicle and a caravanning vehicle to determine a position of the host vehicle relative to the caravanning vehicle.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, computing devices typically use global positioning system (GPS) sensors to determine their respective locations. However, GPS sensors cannot locate a device with pinpoint accuracy.

Additionally, many vehicles are equipped with driver assistance systems to prevent collisions. However, these systems merely assist the driver by for example, alerting the driver when they are drifting into another lane. The driver assistance systems do not cause the vehicle to autonomously travel to a destination. Furthermore, autonomous vehicles require expensive depth sensing systems which will likely cause them to be more costly than manually operated vehicles.

### SUMMARY

When multiple people are traveling to the same destination in their respective vehicles, they may want to follow the person who is familiar with the route to the destination. An autonomous caravanning system can allow the travelers to select one member of the group as the driver of the host vehicle and the other vehicle(s) may autonomously follow the host vehicle to the destination.

To follow the host vehicle to the destination, a user in a caravanning vehicle may pair their client device (also referred to herein as the “caravanning client device”) with the client device of a user in the host vehicle (also referred to herein as the “host client device”). Then when the host vehicle begins travelling to the destination, the caravanning client device periodically or continuously transmits an ultra-wideband (UWB) message to the host client device and receives a UWB response message from the host client device. The term “caravanning” used herein refers to the act of one vehicle following another vehicle to a destination. In more detail, a caravanning vehicle/device is a vehicle that is communicating with and following a host vehicle/device.

The caravanning client device then determines the position of the host client device relative to the host client device based on a round trip time of the UWB messages. In some implementations, the caravanning client device includes multiple antennas. The caravanning client device may determine the distance between the devices based on the round trip time (RTT) of the UWB messages, and a direction of arrival of the UWB response signal based on a time difference at which each of the plurality of antennas receives the UWB response message. Then the caravanning client device may determine the position of the host client device relative to the caravanning client device based on the distance between the devices and the direction of arrival of the UWB response signal. Therefore, the use of multiple antennas at the caravanning client device enables a determination of the relative direction between the host vehicle and the caravanning vehicle.

To follow the host vehicle, the caravanning client device adjusts control of the caravanning vehicle in accordance with the position of the host vehicle relative to the caravanning vehicle. For example, the caravanning client device may adjust the acceleration of the caravanning vehicle to maintain a proper following distance between the host vehicle and the caravanning vehicle. The caravanning client device may also adjust the steering angle of the caravanning vehicle so that the caravanning vehicle follows behind the host vehicle. In some implementations, in addition to adjusting control of the caravanning vehicle in accordance with the position of the host vehicle, the caravanning vehicle obtains collision avoidance data from proximity sensors within the caravanning vehicle. The caravanning client device then takes the collision avoidance data into account when adjusting the acceleration and/or steering angle of the caravanning vehicle. For example, the caravanning client device may apply the relative position of the host vehicle and the collision avoidance data to a machine learning model trained based on previous caravans to determine a steering angle and/or acceleration for the caravanning vehicle. In this way, a technical effect is provided in which collision avoidance is improved in the context of a caravanning vehicle following a host vehicle.

In this manner, a caravanning vehicle can autonomously follow a host vehicle to a destination without having light detection and ranging (LiDAR) sensors or other expensive depth sensing systems. This allows the disclosed systems to be retrofitted to vehicles without complex and expensive LiDAR or depth sensing systems. In other words, the disclosed systems and methods that enable a vehicle to follow a host vehicle to a destination can be applied to a broader range of vehicles. This is because the disclosed systems and methods do not necessarily rely on specific hardware of the vehicle such as LiDAR sensors (which will not be fitted to all vehicles). Instead, the disclosed systems enable vehicle caravanning by means of UWB communication between client devices. The disclosed systems and methods thereby provide a more flexible and more broadly applicable means for vehicle caravanning. Moreover, using UWB communications, the caravanning vehicle can locate the host vehicle with pinpoint accuracy (e.g., about 1-10 meter accuracy) which is significantly higher than with GPS sensors. In this way, the disclosed systems and methods are able to provide a more accurate means for following a host vehicle compared to using GPS alone without the need for specialized hardware in the host or following vehicle, by leveraging the UWB capabilities of a user device. The UWB communications also enable the caravanning vehicle to specifically identify the host vehicle from other vehicles when several vehicles are on the road at the same time.

As used herein, a “vehicle” may refer to any suitable device for transporting people or goods, such as an automobile, a truck, a bus, a train, a bicycle, a motorcycle, a boat, an airplane, a helicopter, etc.

An example embodiment of these techniques is a method for automatically following a host vehicle to a destination location. The method includes identifying a host vehicle for a vehicle to follow to a destination location, transmitting a communication signal to the identified host vehicle, and receiving a response signal from the identified host vehicle. The method further includes determining a position of the host vehicle relative to the vehicle based on a round trip time of the communication signal and the response signal, and adjusting control of the vehicle in accordance with the position of the host vehicle relative to the vehicle. The disclosed systems and methods thereby enable autonomous following of a host vehicle using UWB communication between user devices in those host vehicles. In this way, an improved means of navigation is provided when multiple vehicles are headed to the same destination. Instead of each vehicle independently travelling to the destination using their own respective route, the disclosed systems and methods provide a simpler means in which all vehicles use the same route and in which all vehicles autonomously follow a single host vehicle. This enables a safer means of navigation, since the users of the following vehicles do not need to rely on following navigation directions themselves (whereby the user may be distracted) to reach the destination. Instead, the following vehicle is able to autonomously follow the host vehicle to the destination, thereby removing the risk of a driver of the following vehicle being distracted. In this way, the disclosed systems and methods provide a safer means for multiple vehicles to travel to the same destination. Additionally, the disclosed systems and methods provide a more efficient means for multiple vehicles to travel to the same destination. This is because all of those vehicles follow the same route (by means of following the host vehicle), thereby removing the risk of individual vehicles taking a wrong turn or taking a longer route. It is more efficient for all of the vehicles to follow the same route to reduce traffic levels, noise pollution and air pollution.

Another example embodiments of these techniques is a client device including processing hardware and configured to implement the method above.

Yet another example embodiment of these techniques is a computer-readable memory, which may be non-transitory, coupled to one or more processors and storing instructions thereon. The instructions cause the one or more processors to carry out the method above.

### BRIEF DESCRIPTION OF THE DRAWINGS

FIG. 1 illustrates an example vehicle in which the techniques of the present disclosure can be used to autonomously follow a host vehicle to a destination;

FIG. 2 is a block diagram of an example autonomous caravanning system that implements the techniques of this disclosure;

FIG. 3A is an example messaging sequence for measuring a round trip time of messages exchanged between client devices;

FIG. 3B is an example of the phase delay of a UWB message received at multiple antennas within a client device for determining the direction of arrival of the UWB message;

FIG. 4 illustrates example scenarios for adjusting the acceleration and steering angle of the caravanning vehicle based on the position of the host vehicle relative to the caravanning vehicle;

FIGS. 5A-5B illustrate example positions of the host vehicle relative to the caravanning vehicle;

FIG. 6 is a schematic diagram of the software components of the autonomous caravanning system;

FIG. 7 is a combined block and logic diagram that depicts the determination of an acceleration and a steering angle for following a host vehicle using a machine learning model; and

FIG. 8 is a flow diagram of an example method for automatically following a host vehicle to a destination location, which can be implemented in a client device.

### DETAILED DESCRIPTION OF THE DRAWINGS

Generally speaking, the techniques of this disclosure allow client devices to communicate with each other using a radio technology that is suitable for short-range communications, and/or high-bandwidth communications over a large portion of a radio spectrum. One such non-limiting radio technology is ultra-wideband (UWB). When a client device in a vehicle communicates signals with another client device in another vehicle over UWB for example, the client device can determine the location of the other vehicle relative to the vehicle based on a measurement of the time of flight of those signals. Compared to conventional GPS-based location determination techniques, the client device is able to determine location information with sub-meter accuracy, thereby allowing the vehicle to autonomously follow the other vehicle. For example, the improved accuracy enabled by UWB communication in the manner disclosed herein can allow a following vehicle to determine that a host vehicle has changed lanes on a multi-lane road. The following vehicle can in turn follow the host vehicle into the new lane. In this way, the disclosed systems and methods provide a more accurate means for following a host vehicle to a destination.

The client device may be a smart phone, a tablet computer, a laptop computer, a vehicle head unit, a wearable device such as a smart watch or smart glasses, or any suitable client computing device. In some implementations, smart phones for users in different vehicles may pair with each other to establish a communication session. Each respective smart phone may also communicate with a corresponding vehicle head unit in each vehicle to direct the vehicle head units to transmit and receive UWB messages back and forth with each other. Then the smart phone or the vehicle head unit for a caravanning vehicle may determine the position of the host vehicle and adjust controls of the caravanning vehicle accordingly. In other implementations, the vehicle head units may pair with each other to establish the communication session and may transmit and receive UWB messages back and forth with each other. In yet other implementations, the smart phones may pair with each other and transmit and receive UWB messages back and forth each other. Then the smart phone for the caravanning vehicle may determine the position of the host vehicle and communicate with the vehicle head unit in the caravanning vehicle to adjust controls of the caravanning vehicle. More generally, the smart phones and/or vehicle head units may communicate with each other in any suitable manner to transmit and receive UWB message and adjust controls of the caravanning vehicle.

The techniques of this disclosure also allow a network server to communicate with the client devices. The network server can train and generate machine learning models for determining how to adjust the controls of a caravanning vehicle to follow a host vehicle. The network server can also obtain location data from the vehicles such as GPS data and/or destination data, so that vehicles with a common destination can meet each other at a particular location when they are outside of UWB (or other short-range communication) range of each other. The GPS data can be used to allow the vehicles to come within range so that UWB communication can be used as disclosed herein. In this way, the disclosed systems and methods leverage the superior range of GPS to bring vehicles within UWB range, and further leverages the superior accuracy of UWB to provide accurate information to enable accurate following of a host vehicle to a destination.

For example, mapping applications in respective client devices may receive requests for navigation directions to a particular destination. When multiple client devices request navigation directions to the same destination, the network server may provide a recommendation to the client devices to pair with each other so that one vehicle may autonomously follow the other to the destination. The network server may provide the recommendation when the client devices are within a threshold distance of each other (e.g., one mile). However, the client devices may be too far away from each other to communicate over UWB. The network server may provide an approximate location which is not as accurate as a location determined using UWB, such as a GPS location of one of the vehicles to the other vehicle so that a driver of the other vehicle can manually travel to the GPS location of the vehicle and the client devices can pair with each other to establish a communication session. The network server may also provide navigation directions to the GPS location of the vehicle which may be presented via the driver's client device. As noted above, this leverages the superior range of GPS to bring vehicles within range for UWB communication, and then leverages the superior accuracy of UWB communication to travel to the destination.

In another example, a caravanning vehicle following a host vehicle may be stopped by a traffic signal causing the caravanning vehicle to be outside of the UWB communication range of the host vehicle. The client device of the caravanning vehicle may indicate to the user that the caravanning vehicle is outside of the UWB communication range of the host vehicle and cannot autonomously follow the host vehicle. The driver of the caravanning vehicle may then resume manual operation of the caravanning vehicle and may periodically or continuously receive GPS location data of the host vehicle from the network server until the caravanning vehicle is back within UWB communication range of the host vehicle. Then the client device of the caravanning vehicle may indicate to the user that the caravanning vehicle is within UWB communication range of the host vehicle, and may provide a user control for the user to select to resume autonomous caravanning. Thus, a dynamic system is provided in which the advantages of GPS and UWB are both used to provide efficient and accurate vehicle following, depending on the distance between the vehicles.

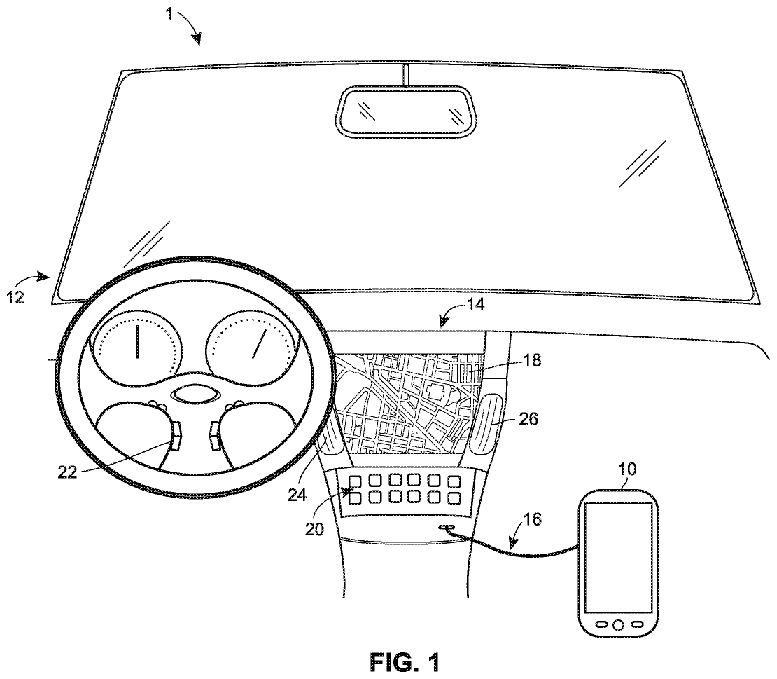

Referring to FIG. 1, an example environment 1 in which the techniques outlined above can be implemented includes a portable device 10 and a vehicle 12 with a head unit 14. The portable device 10 may be a smart phone or a tablet computer, for example. The portable device 10 communicates with the head unit 14 of the vehicle 12 via a communication link 16, which may be wired (e.g., Universal Serial Bus (USB)) or wireless (e.g., Bluetooth, Wi-Fi Direct). The portable device 10 also can communicate with various content providers, servers, etc. via a wireless communication network such as a fourth- or third-generation cellular network (4G or 3G, respectively). Additionally, the portable device 10 can communicate with other portable devices via short-range and/or high-bandwidth communications, such as UWB.

The head unit 14 can include a display 18 for presenting navigation information such as a digital map. The display 18 in some implementations is a touchscreen and includes a software keyboard for entering text input, which may include the name or address of a destination, point of origin, etc. Hardware input controls 20 and 22 on the head unit 14 and the steering wheel, respectively, can be used for entering alphanumeric characters or to perform other functions for requesting navigation directions. The head unit 14 also can include audio input and output components such as a microphone 24 and speakers 26, for example. The speakers 26 can be used to play the audio instructions sent from the portable device 10.

The head unit 14 can also control driving components of the vehicle 12, such as the acceleration/deceleration and steering angle of the vehicle 12. For example, the head unit may communicate with a motor or throttling device in the vehicle to control acceleration of the vehicle and may communicate with steering controls in the vehicle to control the steering angle. Moreover, the head unit 14 can communicate with other head units via short-range and/or high-bandwidth communications, such as UWB.

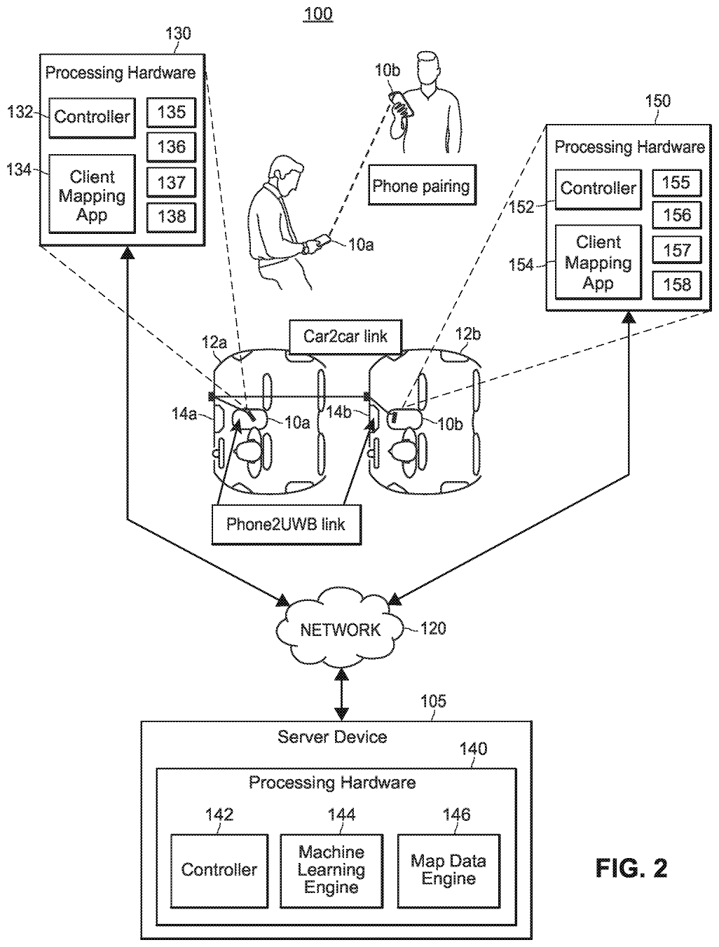

FIG. 2 depicts an example autonomous caravanning system 100 that can implement the techniques of this disclosure. The autonomous caravanning system 100 includes portable devices 10a, 10b within vehicles 12a, 12b respectively, each having respective vehicle head units 14a, 14b. The portable devices 10a, 10b and/or vehicle head units 14a, 14b may be communicatively coupled to a server device 105 via a network 120. The network 120 in general can include one or more wired and/or wireless communication links (e.g., communication links 116) and may include, for example, a wide area network (WAN) such as the Internet, a local area network (LAN), a cellular telephone network, or another suitable type of network.

The portable devices 10a. 10b may pair with each other via a short-range communication link, such as Bluetooth or UWB. Then the portable devices 10a, 10b may communicate over the short-range and/or high bandwidth communication protocol (e.g., UWB) with each other and may communicate with their respective vehicle head units 14a, 14b to adjust control of the vehicles 12a, 12b. In other implementations, the portable devices 10a, 10b may pair with each other via a short-range communication link, such as Bluetooth and may communicate with their respective vehicle head units 14a, 14b so that the vehicle head units 14a, 14b communicate over a short-range and/or high bandwidth communication protocol (e.g., UWB) with each other via a vehicle-to-vehicle (V2V) communication link, for example. Then the vehicle head units 14a, 14b determine their relative positions or provide the UWB communications to the portable devices 10a, 10b to determine the relative positions and adjust control of the respective vehicles 12a, 12b based on their relative positions. In yet other implementations, the vehicle head units 14a, 14b may pair with each other via a short-range communication link, such as UWB and may communicate over UWB with each other.

Although the examples disclosed herein refer specifically to specific radio technology (UWB), in general the techniques of this disclosure can also apply to other suitable radio technologies for short-range and/or high-bandwidth communications over a large portion of a radio spectrum.

The portable device 10a includes processing hardware 130, which can include one or more general-purpose processors (e.g., central processing units (CPUs)) and a computer-readable memory (e.g., random access memory (RAM), flash memory, read-only memory (ROM)) storing machine-readable instructions executable on the one or more general-purpose processor(s), and/or special-purpose processing units. The processing hardware 130 includes a controller 132 that is configured to determine a distance between the portable device 10a and another portable device 10b based on a measurement of the time of flight of a signal exchanged between them. The portable device 10a can be equipped with multiple antennas to determine not only the distance between the portable device 10a and another portable device 10b but also the direction of the portable device 10b relative to the portable device 10a, so that the controller 132 can determine the relative position of the portable device 10b based on the distance and direction.

The processing hardware 130 can also include a client mapping application 134, a network interface 135, a user interface 136, an input/output (I/O) interface 137, and an operating system (OS) 138.

The client mapping application 134 can be executed by the controller 132 to determine how to adjust control of the vehicle 12a based on the UWB communications. For example, the client mapping application 134 may determine the steering angle and/or the acceleration for the vehicle 12a. The client mapping application 134 can also access a machine learning model via the network 120 and apply the machine model to distance data, direction data, and/or collision avoidance data to determine how to adjust control of the vehicle 12a. Additionally, the client mapping application 134 can obtain a request to provide mapping or navigation data for a destination location. The client mapping application 134 may communicate with the server device 105 to obtain navigation directions to the destination location. The client mapping application 134 may also provide location data to the server device 105 (e.g., GPS data), and the server device 105 may identify other vehicles traveling to the same destination that are within a threshold distance of the vehicle's 12 current location. The server device 105 may provide a recommendation to the client mapping application 134 for the vehicles to meet each other and follow each other to the destination. Then the server device 105 may provide navigation directions to one of the vehicles' location or to a predetermined meeting location. Furthermore, when the vehicle 12a is autonomously following another vehicle 12b but is outside of UWB communication range (or other short-range communication range) of the other vehicle 12b, the server device 105 may provide location information for the other vehicle to the client mapping application 134 so that a driver of the vehicle 12a may find the other vehicle 12b and resume autonomous caravanning.

For example, the client mapping application 134 may determine that the host vehicle 12b is outside of short-range communication range of the vehicle 12a. Then the client mapping application 134 may obtain an approximate location of the host vehicle 12b, such as a GPS location from the server device 105 that receives location data from the host vehicle 12b. The vehicle 12a may travel to the approximate location of the host vehicle 12b, and the client mapping application 134 may transmit another short-range communication signal to the host vehicle 12b to determine whether the vehicle 12a is back within short-range communication range of the host vehicle 12b. If the vehicle 12a is back within short-range communication range of the host vehicle 12b, the vehicle 12a may resume autonomous caravanning.

Although FIG. 1A illustrates the client mapping application 134 as a standalone application, the functionality of the client mapping application 134 also can be provided in the form of an online service accessible via a web browser executing on the portable device 10a, as a plug-in or extension for another software application executing on the portable device 10a, etc. The client mapping application 134 generally can be provided in different versions for different respective operating systems.

The network interface 135 can include one or more communication interfaces such as hardware, software, and/or firmware for enabling communications with the network server 105 via a cellular network, a WiFi network, or any other suitable network such as the network 120.

The user interface 136 can include one or more input devices configured to receive user commands, such as a touchscreen, a keyboard, a mouse, microphone, a camera, etc. and one or more output devices configured to provide visual, audio, and/or tactile output, such as touchscreen or a speaker. The OS 138 can be any suitable mobile or general-purpose OS. In addition, the processing hardware 130 can store one or more applications that communicate (e.g., transmitting data, receiving data, or both) data via the network 120, including a client mapping application 134, which will be described in further detail below. The OS 138 may include application programming interface (API) functions that allow applications to access information from components of the portable device 10a. The portable device 10a may also include components not shown in FIG. 2, such as a graphics processing unit (GPU), and sensors, such as a GPS sensor, an accelerometer, and/or proximity sensors.

Although not shown, the vehicle head unit 14a can include processing hardware similar to processing hardware 130 and a client mapping application similar to the client mapping application 134. The vehicle head unit 14a can also include sensors, such as a GPS sensor, an inertial measurement unit (IMU), and/or proximity sensors for obtaining collision avoidance data to prevent collisions with objects, vehicles, pedestrians, etc., near the vehicle 12a.

Each vehicle 12a, 12b may include an advanced driver-assistance system using sensors and/or cameras, such as adaptive cruise control, a collision avoidance system using radar detection to determine the vehicle's vicinity to nearby obstacles, lane centering, etc. However, in some implementations, the vehicles 12a, 12b do not have LiDAR or other expensive depth sensors.

The portable device 10b also includes similar processing hardware 150 to the processing hardware 130, and includes a client mapping application 154, a network interface 155, a user interface 156, an I/O interface 157, and an OS 158, similar to the client mapping application 134, network interface 135, user interface 136, I/O interface 137, and OS 138 in portable device 10a. The vehicle head unit 14b can include processing hardware similar to processing hardware 150 and a client mapping application similar to the client mapping application 154. The vehicle head unit 14b can also include sensors, such as a GPS sensor, an IMU, and/or proximity sensors for obtaining collision avoidance data to prevent collisions with objects, vehicles, pedestrians, etc., near the vehicle 12b.

The server device 105 can be any suitable type of computing device capable of communicating with the portable devices 10a, 10b and/or vehicle head units 14a, 14b over the network 120. The server device 105 includes processing hardware 140, which can include one or more general-purpose processors (e.g., CPUs) and a computer-readable memory (e.g., RAM, flash memory, ROM) storing machine-readable instructions executable on the one or more general-purpose processor(s), and/or special-purpose processing units. The processing hardware 140 in the example implementation in FIG. 2 includes a controller 142 that is configured to train a machine learning model for determining how to adjust control of a caravanning vehicle and to provide map data, navigation data, location information for vehicles, and/or recommendations for vehicles traveling to the same destination to autonomously caravan together.

More specifically, a machine learning engine 144 trains a machine learning model using (i) the relative positions of host vehicles with respect to caravanning vehicles, (ii) collision avoidance data from proximity sensors at the caravanning vehicles, and (iii) the resulting accelerations and steering angles which were used to follow the host vehicles. The training data may be obtained from caravanning vehicles which autonomously followed host vehicles successfully and safely to the destinations without having to transition to manual operation. In other implementations, the training data may be obtained from manually operated vehicles which followed host vehicles successfully and safely to the destinations. In yet other implementations, the training data may be obtained from any suitable combination of these.

In any event, to generate the machine learning model, the machine learning engine 144 may classify subsets of the training data based on the accelerations and/or steering angles that were used to follow the host vehicles. In some implementations, the machine learning engine 144 may classify subsets of the training data into a range of accelerations and/or steering angles. For example, a first subset of the training data may include scenarios where the acceleration used to follow the host vehicle was less than a first threshold acceleration. A second subset of the training data may include scenarios where the acceleration used to follow the host vehicle was between the first threshold acceleration and a second acceleration, and a third subset of the training data may include scenarios where the acceleration used to follow the host vehicle was above the second threshold acceleration.

Then the machine learning engine 144 may analyze the subsets to generate the machine learning model. The machine learning model may be generated using various machine learning techniques such as a regression analysis (e.g., a logistic regression, linear regression, or polynomial regression), k-nearest neighbors, decisions trees, random forests, boosting, neural networks, support vector machines, deep learning, reinforcement learning. Bayesian networks, etc. In some embodiments, the machine learning engine 144 may generate a first machine learning model for determining the acceleration, and a second machine learning model for determining the steering angle.

The machine learning engine 144 may then provide the trained machine learning model to the client devices 10a/14a, 10b/14b to use to determine how to adjust the vehicle controls to follow a host vehicle.

A map data engine 146 obtains location data from vehicles and/or destination data for vehicles traveling to particular destinations. Then when multiple vehicles within a threshold distance of each other (e.g., one mile) are traveling to the same destination, the map data engine 146 may provide recommendations, via the client mapping applications 134, to the vehicles to pair with each other so that one vehicle may autonomously follow the other to the destination. Then the map data engine 146 may provide navigation directions to one of the vehicles' location or to a predetermined meeting location. Furthermore, when the vehicles are autonomously following each other but are outside of UWB communication range with each other, the map data engine 146 may provide location information for the caravanning vehicle to the client mapping application 134 so that a driver of the caravanning vehicle may find the host vehicle and resume autonomous caravanning.

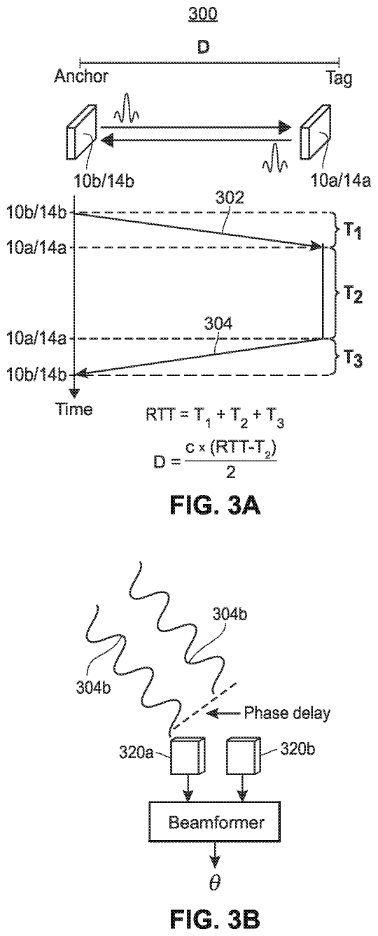

To determine the relative position of a host vehicle 12a, a caravanning vehicle 12b transmits a UWB message to the host vehicle 12a, and receives a UWB response message from the host vehicle 12b. FIG. 3A illustrates an example messaging sequence for measuring a round trip time of messages exchanged between client devices 10a/14a and 10b/14b. The controller 152 in the caravanning client device 10b/14b can transmit a first UWB signal 302 over a UWB link to a host client device 10a/14a, receive a first UWB response signal 304 over UWB link 110 back from the host client device 10a/14a, and calculate a distance (D) between the host client device 10a/14a and the caravanning client device 10b/14b based on a measurement of the RTT of the first UWB signal 302 and the first UWB response signal 304. That is, the controller 152 can calculate RTT as T₁+T₂+T₃, where T₁ is the amount of time it takes for the first UWB signal 302 to be sent from a transmitter (e.g., controller 152) of the caravanning client device 10b/14b to a receiver of the host client device 10a/14a. T₂ is the amount of time it takes for the host client device 10a/14a to generate a reply, and T₃ is the time duration in which a transmitter (e.g., controller 132) of the host client device 10a/14a sends the first UWB response signal 304 (as the reply) back to a receiver (e.g., controller 152) of the caravanning client device 10b/14b. Then, the controller 152 can calculate D as ½ of c×(RTT−T₂), where c is the speed of light.

In some implementations, the host and caravanning client devices 10a/14a, 10b/14b can each be equipped with multiple antennas to determine not only the distance D between the client device 10a/14a, 10b/14b, but also the direction of the host client device 10a/14a, so that the controller 152 can determine the relative position of the host client device 10a/14a based on the distance and direction. For example, the caravanning client device 10b/14b may determine the direction of the host client device 10a/14a by receiving the first UWB response signal 304 at each of its antennas, where the antennas are located at different positions within the caravanning client device 10b/14b.

An example of this process is illustrated in FIG. 3B which depicts the phase delay of a UWB message received at multiple antennas. As shown in FIG. 3B, the caravanning client device 10b/14b includes a first antenna 320a which receives a first instance of the first UWB response signal 304a, and a second antenna 320b which receives a second instance of the second UWB response signal 304b. The first and second antennas 320a, 320b receives the first and second instance of the first UWB response signals 304a, 304b at different times resulting in a phase delay between them. While FIG. 3B illustrates the caravanning client device 10b/14b as including two antennas this is merely one example for case of illustration only. The caravanning client device 10b/14b and the host client device 10a/14a may have any suitable number of antennas.

In any event, the caravanning client device 10b/14b may determine the direction of arrival of the first UWB response signal 304a, 304b using beamforming techniques. More specifically, the caravanning client device 10b/14b may determine the direction of arrival of the first UWB response signal 304a, 304b based on a time difference at which each of the antennas 320a, 320b received the first UWB response signal 304a, 304b. In some implementations, the caravanning client device 10b/14b may include a compass, magnetometer, gyroscope, accelerometer, and/or other sensors to determine its orientation. Then the caravanning client device 10b/14b may determine the direction of arrival of the first UWB response signal 304a, 304b based on a time difference at which each of the antennas 320a, 320b received the first UWB response signal 304a, 304b and based on the orientation of the caravanning client device 10b/14b.

In other implementations, the host client device 10a/14a determines the direction of the caravanning client device 10b/14b relative to the host client device 10a/14a using its antennas, so that the controller 152 can determine the relative position of the host client device 10a/14a based on the distance and direction. For example, the caravanning client device 10b/14b may transmit the first UWB signal 302 which is received at multiple antennas at the host client device 10a/14a. The host client device 10a/14a may then transmit multiple UWB response signals 304 back to the controller 152 in response to receiving the first UWB signal 302 at each antenna with indications of the positions of the antennas and indications of which antenna received the first UWB signal 302 at which time. In other implementations, the host client device 10a/14a may determine the direction of arrival of the UWB signal 302 based on when the UWB signal 302 is received at each antenna and may provide a UWB response signal 304 back to the controller 152 and an indication of the direction of the caravanning client device 10b/14b.

In yet other implementations, the host client device 10a/14a determines the direction of arrival of the first UWB signal 302 using its antennas, and the caravanning client device 10b/14b determines the direction of arrival of the first UWB response signal 304 using its antennas. Accordingly, the caravanning client device 10b/14b obtains the distance between the host client device 10a/14a and the caravanning client device 10b/14b, the direction of arrival of the first UWB signal 302, and the direction of arrival of the first UWB response signal 304. The caravanning client device 10b/14b may then determine the relative position of the host client device 10a/14a based on the distance between the host client device 10a/14a and the caravanning client device 10b/14b, the direction of arrival of the first UWB signal 302, and/or the direction of arrival of the first UWB response signal 304.

The caravanning client device 10b/14b may repeat periodically (e.g., every millisecond, every second, every 10 seconds, etc.) or continuously transmit UWB signals to the host client device 10a/14a to continue to determine the relative position of the host vehicle 12a until arriving at the destination.

Also in some implementations, the host client device 10a/14a may analyze the first UWB signal 302 to identify the device that transmitted the first UWB signal 302. For example, the first UWB signal 302 may be a first pulse train encoded to uniquely identify the caravanning client device 10b/14b. In response to identifying that the first UWB signal 302 is from the caravanning client device 10b/14b, the host client device 10a/14a may send the first UWB response signal 304. The caravanning client device 10b/14b may then analyze the first UWB response signal 304 to identify the device that transmitted the first UWB response signal 304. For example, the first UWB response signal 304 may be a second pulse train encoded to uniquely identify the host client device 10a/14a. In response to identifying that the first UWB response signal 304 is from the host client device 10a/14a, the caravanning client device 10b/14b may determine the relative position of the host client device 10a/14a. Using unique pulse trains as disclosed above enables multiple distinct vehicles to be able to follow a host vehicle at the same time, while each vehicle is able to be identified uniquely.

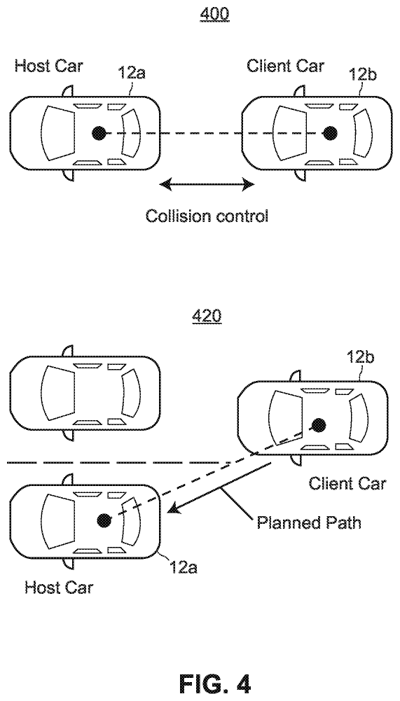

FIG. 4 illustrates two example scenarios 400, 420 where a caravanning vehicle 12b is following a host vehicle 12a. In the first example scenario 400, the caravanning vehicle 12b is directly behind the host vehicle 12a. The directional of arrival of the UWB communications between them will be 0°. However, the caravanning vehicle 12b may adjust its acceleration to maintain a proper following distance behind the host vehicle 12a without getting too close to the host vehicle 12a. In the second example scenario 420, the caravanning vehicle 12b is in a different lane than the host vehicle 12a. The direction of arrival of the UWB communications between them will not be 0°, and the caravanning vehicle 12b will have to adjust its steering angle to move into the other lane.

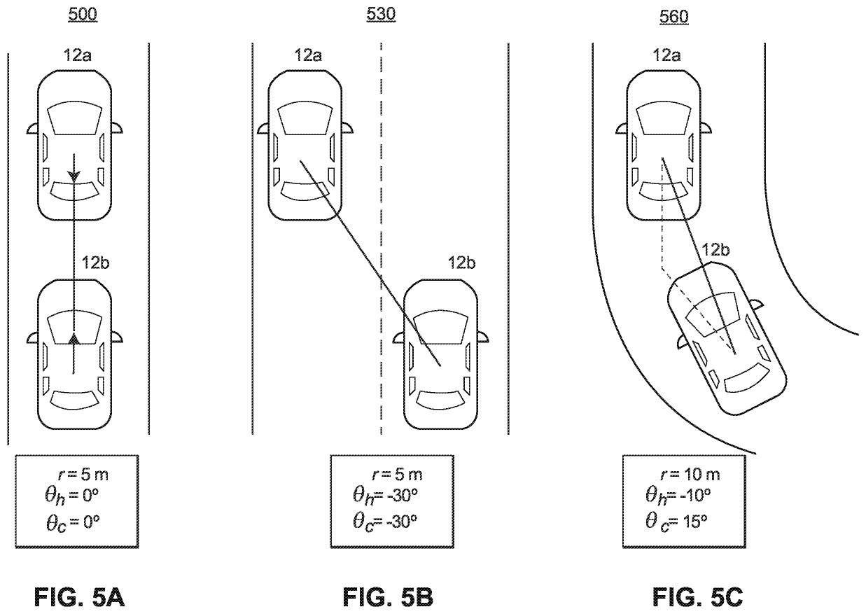

FIGS. 5A-5C illustrate example distance and direction of arrival data obtained at the caravanning vehicle 12b based on UWB communications with the host vehicle 12a. In the first example scenario 500, the caravanning vehicle 12b is directly behind the host vehicle 12a. The direction of arrival of the UWB signal, θ_{c}, is 0°, the direction of arrival of the UWB response signal, θₕ, is 0°, and the distance between them is 5 m. As 5 m appears to be an appropriate following distance, the caravanning vehicle 12b may not adjust its acceleration or steering angle. In the second example scenario 530, the caravanning vehicle 12b is in a different lane than the host vehicle 12a. The direction of arrival of the UWB signal, θ_{c}, is −30°, the direction of arrival of the UWB response signal, θₕ, is −30°, and the distance between them is 5 m. As 5 m appears to be an appropriate following distance, the caravanning vehicle 12b may not adjust its acceleration. However, the caravanning vehicle 12b may adjust the steering angle to turn to the left to enter the same lane as the host vehicle 12a and reduce the direction of arrival of subsequent UWB signals and response signals to 0°. In the third example scenario 560, the host vehicle 12a appears to turn to the right around a curve in the road. The direction of arrival of the UWB signal, θ_{c}, is 15°, the direction of arrival of the UWB response signal, θₕ, is −10°, and the distance between them is 10 m. It may be deemed that a distance of 10m is too great, since another vehicle could move into the space between the host vehicle and caravanning vehicle, and so the caravanning vehicle may wish to reduce this distance in order to maintain a convoy between the two vehicles and to make it easier for the caravanning vehicle to follow the host vehicle. To reduce the distance between the vehicles 12a, 12b, the caravanning vehicle 12b may increase its acceleration. The caravanning vehicle 12b may also adjust the steering angle to turn to the right to navigate around the curve.

In some implementations, the caravanning client device 10b/14b transforms the distance and direction of arrival data to Cartesian coordinates to determine the relative position of the host client device 10a/14a. In the Cartesian coordinate system, the caravanning client device 10b/14b may be at the center having coordinates (0,0). The x-coordinate for the host client device 10a/14a may be determined as the product of the distance between the host and caravanning client devices, D, and cos(θ), where θ is the direction of arrival of the UWB response signal. The y-coordinate for the host client device 10a/14a may be determined as the product of the distance between the host and caravanning client devices, D, and sin(θ), where θ is the direction of arrival of the UWB response signal. Accordingly, the Cartesian coordinates for the host client device 10a/14a can be determined as (D·cos(θ), D·sin(θ)).

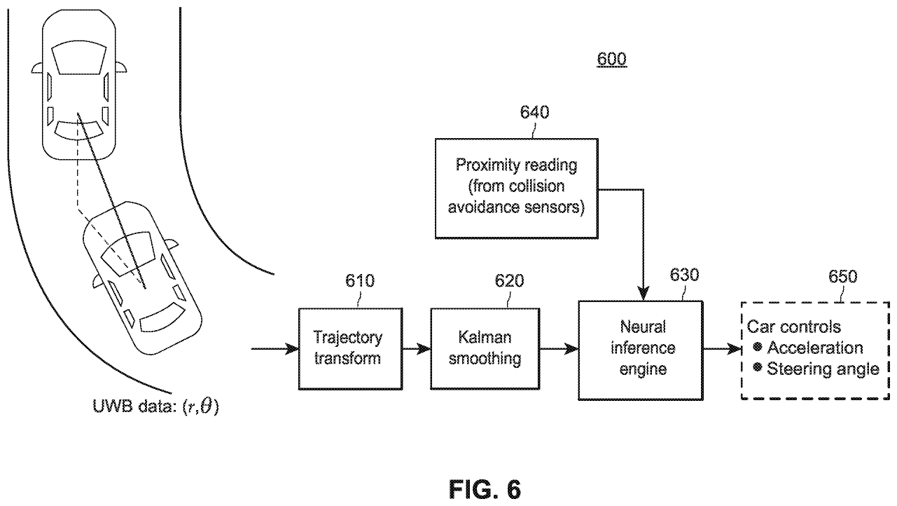

Then the caravanning client device 10b/14b determines how to adjust the control of the caravanning vehicle 12b based on the relative position of the host client device 12a. FIG. 6 is a schematic diagram 600 illustrating the example processes performed by the caravanning client device 10b/14b to determine how to adjust the control of the caravanning vehicle 12b.

Upon obtaining the distance and direction of arrival of the UWB response signal, the caravanning client device 10b/14b transforms 610 the distance and direction of arrival data to Cartesian coordinates in the manner described above. Then the caravanning client device 10b/14b applies a trajectory filter 620 to smooth out the raw coordinate data which may be noisy. For example, the caravanning client device 10b/14b may use a Kalman filter or an RSSI-aware Kalman filter.

The caravanning client device 10b/14b also obtains collision avoidance data 640 from proximity sensors in the caravanning vehicle 12b. For example, the collision avoidance data may include radar data to determine the vehicle's vicinity to nearby obstacles, lane centering, etc. Then the caravanning client device 10b/14b applies the filtered coordinate data and the collision avoidance data 640 to a neural inference engine 630 to determine how to adjust the vehicle controls 650 (e.g., the steering angle and/or the acceleration) to follow the host vehicle 12a. The caravanning client device 10b/14 adjusts control of the vehicle 12b based on the output(s) from the neural inference engine 630.

The caravanning client device 10b/14b may repeat this process periodically (e.g., every millisecond, every second, every 10 seconds, etc.) or continuously to continue to autonomously follow the host vehicle 12a until arriving at the destination.

In some implementations, the neural inference engine 630 may include a set of rules for adjusting the vehicle controls 650 based on specific sets of relative position data and/or collision avoidance data 640. For example, when the caravanning vehicle 12b is more than a threshold distance away from the host vehicle 12a and the collision avoidance data 640 does not indicate any objects directly in front of the caravanning vehicle 12b, the neural inference engine may determine that the acceleration should be increased.

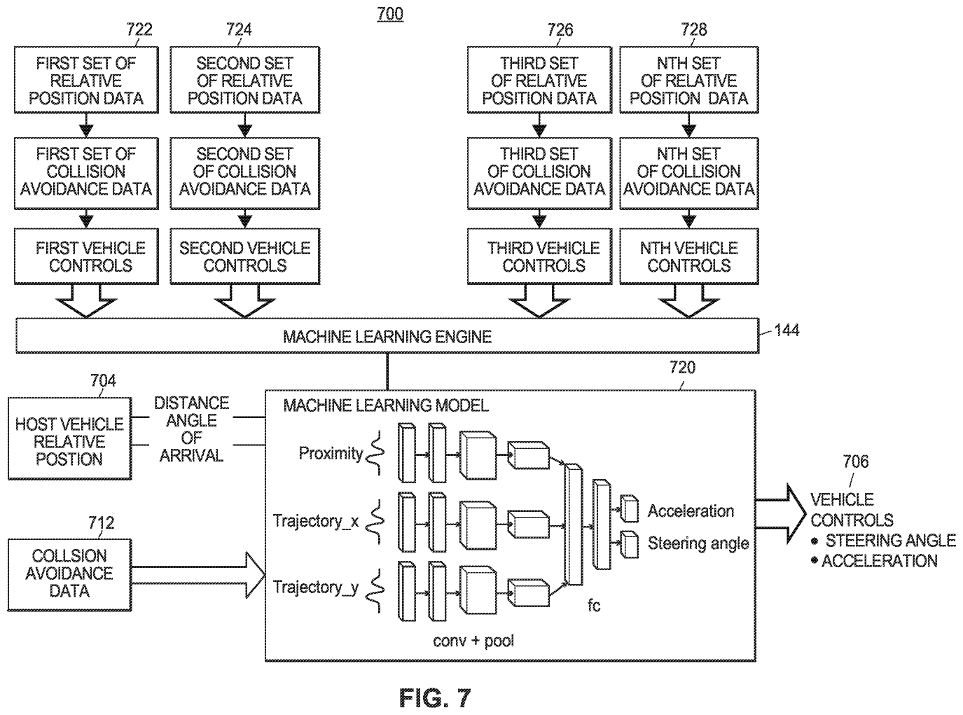

In other implementations, the neural inference engine 630 may use a machine learning model to determine how to adjust the vehicle controls 650. For example, the neural inference engine 630 may include the machine learning engine 144 of FIG. 2. In another example, the neural inference engine may obtain the machine learning model from the machine learning engine 144 and may apply the relative position data of the host vehicle 12a and the collision avoidance data of the caravanning vehicle 12b to the machine learning model. FIG. 7 schematically illustrates how the machine learning engine 144 of FIG. 2 determines how to adjust the vehicle controls in an example scenario. Some of the blocks in FIG. 7 represent hardware and/or software components (e.g., block 702), other blocks represent data structures or memory storing these data structures, registers, or state variables (e.g., blocks 704, 712, 720), and other blocks represent output data (e.g., block 706). Input signals are represented by arrows labeled with corresponding signal names.

To generate the machine learning model 720, the machine learning engine 144 receives training data including in a first instance 722, a first set of relative position data of a host vehicle, a first set of collision avoidance data for a caravanning vehicle, and first vehicle controls used to follow the host vehicle. The training data also includes in a second instance 724, a second set of relative position data of a host vehicle, a second set of collision avoidance data for a caravanning vehicle, and second vehicle controls used to follow the host vehicle. Furthermore, the training data includes in a third instance 726, a third set of relative position data of a host vehicle, a third set of collision avoidance data for a caravanning vehicle, and third vehicle controls used to follow the host vehicle. Still further, the training data includes in an nth instance 728, an nth set of relative position data of a host vehicle, an nth set of collision avoidance data for a caravanning vehicle, and nth vehicle controls used to follow the host vehicle.

While the example training data includes four instances 722-728 of the same or different caravanning vehicle following the same or different host vehicle, this is merely an example for ease of illustration only. The training data may include any number of instances of any number of caravanning vehicles following any number of host vehicles.

The machine learning engine 144 then analyzes the training data to generate a machine learning model 720 for determining how to adjust the vehicle controls to follow a host vehicle. In some implementations, the machine learning engine 144 generates a separate machine learning model for each vehicle control. For example, the machine learning engine 144 generates a first machine learning model adjusting acceleration and a second machine learning model for adjusting the steering angle.

In any event, the machine learning model 720 may be a neural network (e.g., a convolutional neural network). While the machine learning model 720 is illustrated as a neural network, the machine learning model may be another type of machine learning model such as a linear regression model, a logistic regression model, a decision tree, a hyperplane, or any other suitable machine learning model.

In any event, the machine learning engine 144 may provide the trained machine learning model 720 to the caravanning client device 10b/14b for determining how to adjust the vehicle controls to autonomously follow the host vehicle 12a. The caravanning client device 10b/14b may then provide the relative position 704 of the host vehicle 12a and collision avoidance data obtained from proximity sensors at the caravanning vehicle 12b to the machine learning model 720. For example, the caravanning client device 10b/14b may provide the distance and direction data to the machine learning model 720. In other implementations, the caravanning client device 10b/14b provides the Cartesian coordinates or the filtered coordinates for the host vehicle 12a to the machine learning model 720. The machine learning model 720 then generates vehicle controls 706 for the caravanning vehicle 12b to follow the host vehicle 12a, such as a steering angle and an acceleration.

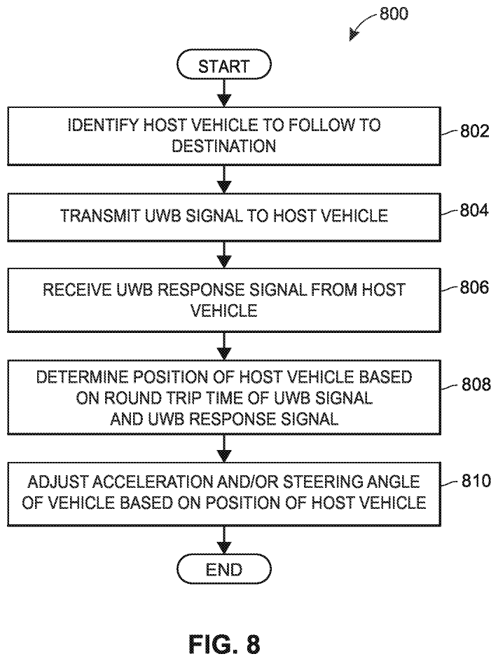

FIG. 8 illustrates a flow diagram of an example method 800 for automatically following a host vehicle to a destination location. The method 800 can be implemented in a set of instructions stored on a computer-readable memory and executable at one or more processors of a client device 10b/14b.

At block 802, a host vehicle 12a is identified to follow to a destination. For example, the client device 10b/14b may request navigation directions or other map data for a destination location via the client mapping application 134. The client mapping application 134 may communicate with a server device 105 to obtain navigation directions or other map data for the destination location. The client mapping application 134 may also provide location data to the server device 105 (e.g., GPS data), and the server device 105 may identify other vehicles traveling to the same destination that are within a threshold distance of the vehicle's 12 current location. The server device 105 may provide a recommendation to the client mapping application 134 for the vehicles to meet each other and follow each other to the destination.

In another example, two users may pair their respective client devices 10a/14a, 10b/14b with each other and identify one of the client devices 10a/14a as a host client device 10a/14a for example, via a user control in the client mapping application 134. Then the caravanning client device 10b/14b may identify the host vehicle 12a as the vehicle corresponding to the host client device 10a/14a (e.g., the vehicle communicatively coupled to the host client device 10a/14a).

To autonomously follow the host vehicle 12a to the destination, the caravanning client device 10b/14b continuously or periodically (e.g., every millisecond, every second, every 10 seconds, etc.) determines the position of the host vehicle 12a relative to the caravanning vehicle 12b transporting the caravanning client device 10b/14b. More specifically, to determine the relative position of the host vehicle 12, the caravanning client device 10b/14b transmits a short-range communication signal (e.g., a UWB signal) to the host client device 10a/14a (block 804), and receives a short-range response signal (e.g., a UWB response signal) from the host client device 10a/14a (block 806).

The caravanning client device 10b/14b determines the distance, D, between the host vehicle 12a and the caravanning vehicle 12 based on a measurement of the RTT of the UWB signal and the UWB response signal. The caravanning client device 10b/14b can calculate RTT as T₁+T₂+T₃, where T₁ is the amount of time it takes for the UWB signal to be sent from a transmitter (e.g., controller 152) of the caravanning client device 10b/14b to a receiver of the host client device 10a/14a, T₂ is the amount of time it takes for the host client device 10a/14a to generate a reply, and T₃ is the time duration in which a transmitter (e.g., controller 132) of the host client device 10a/14a sends the UWB response signal (as the reply) back to a receiver (e.g., controller 152) of the caravanning client device 10b/14b. Then, the controller 152 can calculate D as ½ of c×(RTT−T₂), where c is the speed of light.

The host and caravanning client devices 10a/14a, 10b/14b can each be equipped with multiple antennas to determine the direction of the UWB signal and the UWB response signal. For example, the caravanning client device 10b/14b may determine the direction of the host client device 10a/14a by receiving the UWB response signal at each of its antennas, where the antennas are located at different positions within the caravanning client device 10b/14b. More specifically, the caravanning client device 10b/14b may determine the direction of arrival of the UWB response signal based on a time difference at which each of the antennas received the UWB response signal. In some implementations, the caravanning client device 10b/14b may include a compass, magnetometer, gyroscope, accelerometer, and/or other sensors to determine its orientation. Then the caravanning client device 10b/14b may determine the direction of arrival of the UWB response signal based on a time difference at which each of the antennas received the first UWB response signal and based on the orientation of the caravanning client device 10b/14b.

In any event, the caravanning client device 10b/14b determines the relative position of the host vehicle 12a based on the distance, D, and the direction of arrival, θ, of the UWB response signal (block 808). In other implementations, the caravanning client device 10b/14b may also use the direction of arrival of the UWB signal to determine the relative position of the host vehicle 12a. In some implementations, the caravanning client device 10b/14b transforms the distance and direction of arrival data to Cartesian coordinates to determine the relative position of the host vehicle 12a. In the Cartesian coordinate system, the caravanning client device 10b/14b may be at the center having coordinates (0,0). The x-coordinate for the host vehicle 12a may be determined as the product of the distance between the host and caravanning client devices, D, and cos(θ), where θ is the direction of arrival of the UWB response signal. The y-coordinate for the host vehicle 12a may be determined as the product of the distance between the host and caravanning client devices, D, and sin(θ), where θ is the direction of arrival of the UWB response signal. Accordingly, the Cartesian coordinates for the host vehicle 12a can be determined as (D·cos(θ), D·sin(θ)).

Then the caravanning client device 10b/14b determines how to adjust the control of the caravanning vehicle 12b based on the relative position of the host vehicle 12a, and adjusts control of the caravanning vehicle 12b accordingly (block 810). For example, the caravanning client device 10b/14b may adjust the steering angle and/or acceleration of the caravanning vehicle 12b based on the relative position of the host vehicle 12a to autonomously follow the host vehicle 12a.

In some implementations, the caravanning client device 10b/14b also obtains collision avoidance data from proximity sensors in the caravanning vehicle 12b, and determines how to adjust the control of the caravanning vehicle 12b based on the relative position of the host vehicle 12a and the collision avoidance data. For example, the caravanning client device 10b/14b may apply a predetermined set of rules to the relative position of the host vehicle 12a and/or the collision avoidance data to determine how to adjust the acceleration and/or steering angle of the caravanning vehicle 12b.

In other implementations, the caravanning client device 10b/14b may use a machine learning model to determine how to adjust the vehicle controls. For example, the caravanning client device 10b/14b may obtain a trained machine learning model from the server device 105 and may apply the relative position of the host vehicle 12a and the collision avoidance data to the machine learning model. In yet other implementations, the caravanning client device 10b/14b trains the machine learning model using training data from previous caravanning experiences.

In any event, upon determining an adjusted set of controls for the caravanning vehicle 12b (e.g., an adjusted acceleration and/or steering angle), the caravanning client device 10b/14b communicates with driving components of the caravanning vehicle 12b to control the caravanning vehicle 12b. For example, the caravanning client device 10b/14 may communicate with a motor or throttling device in the caravanning vehicle 12b to control acceleration of the caravanning vehicle 12b and may communicate with steering controls in the caravanning vehicle 12b to control the steering angle

The caravanning client device 10b/14b may repeat this process periodically (e.g., every millisecond, every second, every 10 seconds, etc.) or continuously to continue to autonomously follow the host vehicle 12a until arriving at the destination.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms (e.g., controllers 132, 142, 152). Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 800 may include one or more function blocks, modules, individual functions or routines in the form of tangible computer-executable instructions that are stored in a computer-readable storage medium, which may be non-transitory, and executed using a processor of a computing device (e.g., a network server, a personal computer, a smart phone, a tablet computer, a smart watch, a mobile computing device, a vehicle head unit, or other client computing device, as described herein). The method 800 may be included as part of any backend server (e.g., a network server or any other type of server computing device, as described herein), client computing device modules of the example environment, for example, or as part of a module that is external to such an environment. Though the figures may be described with reference to the other figures for ease of explanation, the method 800 can be utilized with other objects and user interfaces. Furthermore, although the explanation above describes steps of the method 800 being performed by specific devices (such as a host client devices 10a/14a, caravanning client devices 10b/14b, a server device 105), this is done for illustration purposes only. The blocks of the method 800 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for an indoor positioning system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for automatically following a host vehicle to a destination location, the method comprising:
identifying, by one or more processors in a vehicle, a host vehicle to follow to a destination location;
transmitting, by the one or more processors, a communication signal to the identified host vehicle;
receiving, by the one or more processors, a response signal from the identified host vehicle;
determining, by the one or more processors, a position of the host vehicle relative to the vehicle based on a round trip time of the communication signal and the response signal; and
adjusting, by the one or more processors, control of the vehicle in accordance with the position of the host vehicle relative to the vehicle.

2. The method of claim 1, wherein the communication signal is transmitted by a client device within the vehicle.

3. The method of claim 2, wherein
the client device includes a plurality of antennas for communicating the communication signal with the host vehicle, and
determining the position of the host vehicle includes:
receiving the response signal at the plurality of antennas;
determining a direction of arrival of the response signal based on a time difference at which each of the plurality of antennas received the response signal;
determining a distance between the vehicle and the host vehicle based on the round trip time of the communication signal and the response signal; and
determining the position of the host vehicle based on (i) the distance between the vehicle and the host vehicle, and (ii) the direction of arrival of the response signal.

4. The method of claim 3, wherein adjusting control of the vehicle includes:
adjusting, by the one or more processors, acceleration of the vehicle based on the distance between the vehicle and the host vehicle.

5. The method of claim 3, wherein adjusting control of the vehicle includes:
adjusting, by the one or more processors, a steering angle of the vehicle based on the direction of arrival of the response signal.

6. The method of claim 3, further comprising:
obtaining, by the one or more processors, collision avoidance data from one or more proximity sensors within the vehicle,
wherein control of the vehicle is further adjusted based on the collision avoidance data.

7. The method of claim 6, further comprising:
training, by one or more processors, a machine learning model using (i) distances and directions between host vehicles and following vehicles, (ii) collision avoidance data obtained at the following vehicles, and (iii) acceleration and steering angle adjustments provided by the following vehicles to safely follow paths of the host vehicles;
applying, by the one or more processors, the distance between the vehicle and the host vehicle, the direction of arrival of the response signal, and the collision avoidance data from the one or more proximity sensors within the vehicle to the machine learning model to determine an acceleration and a steering angle of the vehicle to follow a path of the host vehicle; and
adjusting, by the one or more processors, control of the vehicle to the determined acceleration and steering angle.

8. The method of claim 1, further comprising:
analyzing, by the one or more processors, the response signal to determine the response signal is from the host vehicle.

9. The method of claim 1, wherein the vehicle is not an autonomous vehicle and does not include light detection and ranging (LiDAR) sensors.

10. The method of claim 1, wherein the communication signal is a short-range communication signal, the response signal is a short-range response signal, and further comprising:
determining, by the one or more processors, that the host vehicle is outside of short-range communication range of the vehicle;
obtaining, by the one or more processors, an approximate location of the host vehicle based on location data provided from the host vehicle;
traveling to the approximate location of the host vehicle; and
in response to arriving at the approximate location of the host vehicle, transmitting, by the one or more processors, another short-range communication signal to the host vehicle.

11. The method of claim 1, wherein identifying the host vehicle includes pairing a head unit or client device in the vehicle with a head unit or client device in the host vehicle.

12. A client device in a vehicle for automatically following a host vehicle to a destination location, the client device comprising:
one or more processors; and
a non-transitory computer-readable memory including computer executable instructions that, when executed by the one or more processors, cause the client device to:
identify a host vehicle for the client device to follow to a destination location;
transmit a communication signal to the identified host vehicle;
receive a response signal from the identified host vehicle;
determine a position of the host vehicle relative to the vehicle based on a round trip time of the communication signal and the response signal; and
adjust control of the vehicle in accordance with the position of the host vehicle relative to the vehicle.

13. The client device of claim 12, further comprising:
a plurality of antennas for communicating the communication signal with the host vehicle,
wherein to determine the position of the host vehicle, the instructions cause the client device to:
receive the response signal at the plurality of antennas;
determine a direction of arrival of the response signal based on a time difference at which each of the plurality of antennas received the response signal;
determine a distance between the vehicle and the host vehicle based on the round trip time of the communication signal and the response signal; and
determine the position of the host vehicle based on (i) the distance between the vehicle and the host vehicle, and (ii) the direction of arrival of the response signal.

14. The client device of claim 13, wherein to adjust control of the vehicle, the instructions cause the client device to:
adjust acceleration of the vehicle based on the distance between the vehicle and the host vehicle.

15. The client device of claim 13, wherein to adjust control of the vehicle, the instructions cause the client device to:
adjust a steering angle of the vehicle based on the direction of arrival of the response signal.

16. A non-transitory computer-readable memory including computer executable instructions that, when executed by one or more processors, cause the one or more processors to:
identify a host vehicle for a client device in a vehicle to follow to a destination location;
transmit a communication signal to the identified host vehicle;
receive a response signal from the identified host vehicle;
determine a position of the host vehicle relative to the vehicle based on a round trip time of the communication signal and the response signal; and
adjust control of the vehicle in accordance with the position of the host vehicle relative to the vehicle.

17. The non-transitory computer-readable memory of claim 16, wherein the client device includes a plurality of antennas for communicating the communication signal with the host vehicle, and wherein to determine the position of the host vehicle, the instructions cause the one or more processors to:
receive the response signal at the plurality of antennas;
determine a direction of arrival of the response signal based on a time difference at which each of the plurality of antennas received the response signal;
determine a distance between the vehicle and the host vehicle based on the round trip time of the communication signal and the response signal; and
determine the position of the host vehicle based on (i) the distance between the vehicle and the host vehicle, and (ii) the direction of arrival of the response signal.

18. The non-transitory computer-readable memory of claim 17, wherein to adjust control of the vehicle, the instructions cause the one or more processors to:
adjust acceleration of the vehicle based on the distance between the vehicle and the host vehicle.

19. The non-transitory computer-readable memory of claim 17, wherein to adjust control of the vehicle, the instructions cause the one or more processors to:
adjust a steering angle of the vehicle based on the direction of arrival of the response signal.

20. The non-transitory computer-readable memory of claim 17, wherein the instructions further cause the one or more processors to:
analyze the response signal to determine the response signal is from the host vehicle.
